(19) United States
(12) Patent Application Publication
(10) Pub. No.: US 2020/0025648 A1
(43) Pub. Date: Jan. 23, 2020

(54) CONDITION MONITORING SYSTEM AND WIND TURBINE

(71) Applicant: NTN Corporation, Osaka (JP)

(72) Inventor: Takashi HASEBA, Kuwana-shi, Mie (JP)

(21) Appl. No.: 16/481,797

(22) PCT Filed: Jan. 22, 2018
(86) PCT No.: PCT/JP2018/001794

§ 371 Date: Jul. 29, 2019

(30) Foreign Application Priority Data
Jan. 31, 2017 (JP) 2017-015297

(51) Int. Cl. G01M 13/028; F03D 17/00; G01M 13/045; G01H 3/08; G05B 23/02

(52) U.S. Cl. CPC G01M 13/028; F03D 17/00; F05B 2270/334; G01H 3/08; G05B 23/02; G01M 13/045

(57) ABSTRACT

A vibration sensor measures a vibration waveform of a mechanical component. A processor detects a change in the vibration waveform. The processor includes an evaluation value computing unit and a detector. The evaluation value computing unit time-sequentially computes an evaluation value that characterizes a root-mean-square value of vibration waveform data output from the vibration sensor within a prescribed time period. The detector detects a change in the vibration waveform based on the evaluation value. The evaluation value computing unit computes, as the evaluation value, a value based on kurtosis and skewness of a distribution of the root-mean-square value within the prescribed time period.

### TECHNICAL FIELD

The present invention relates to a condition monitoring system that monitors a condition of a mechanical component in an apparatus, and specifically to a condition monitoring system that monitors a condition of a mechanical component in a wind turbine.

### BACKGROUND ART

In a wind turbine, the main shaft connected to blades receiving wind is rotated, and after the gearbox increases the speed of rotation of the main shaft, the rotor of the power generator is rotated to generate electric power. Each of the main shaft, the rotation shaft of the gearbox and the rotation shaft of the power generator is rotatably supported by a rolling bearing. A condition monitoring system (CMS) is known to diagnose an abnormality in such a bearing. In such a condition monitoring system, whether damage occurs in the bearing is diagnosed using vibration waveform data measured by a vibration sensor fixed to the bearing.

As a method of detecting a change in such vibration waveform data, there is a known method of calculating a root-mean-square value of the vibration waveform data and detecting a change in trend data of the calculated root-mean-square value. In response to detection of a change in trend data as a trigger, measurement of the vibration waveform data is started to thereby allow diagnosis of an abnormality in a mechanical component using the measured vibration waveform data.

As one of the methods described above, there is a method of computing a differential value between the root-mean-square value acquired in the previous cycle and the root-mean-square value acquired in the current cycle, and when the differential value exceeds a threshold value, detecting a change in vibration waveform data. For example, Japanese Patent Laying-Open No. 2012-252651 (PTL 1) discloses a monitoring apparatus configured to extract a difference of the process data transmitted from a power generation plant between the previous cycle and the current cycle.

### CITATION LIST

### Patent Literature

PTL 1: Japanese Patent Laying-Open No. 2012-252651

### SUMMARY OF INVENTION

### Technical Problem

However, according to the above-described method of detecting a change in trend data based on whether the differential value exceeds a threshold value or not, there causes a problem that such a change is difficult to be detected until the differential value is sufficiently increased. This results from the fact that the magnitude of vibration of each bearing differs depending on the rotational speeds of the main shaft and the rotation shafts of the gearbox and the power generator, with the result that the effect of noise superimposed on vibration waveform data also differs depending on the rotational speeds. Accordingly, in order to detect a change in trend data, the threshold value needs to be set at a value larger than the differential value resulting from noise. However, when the threshold value is set at a relatively large value, there may be a possibility that, even when trend data changes, such a change cannot be detected until the differential value resulting from this change exceeds the threshold value. Thus, for example, when trend data changes due to damage to a bearing, this change may not be able to be detected until development of a serious failure. As a result, it becomes difficult to detect damage to the bearing as a predictive sign of failure at an early stage.

Furthermore, the numerical value range showing the distribution range (expansion) of trend data of the root-mean-square value differs depending on the rotation speeds of the main shaft and the like, the degree of effect of noise, and the like. Accordingly, the numerical value range of the differential value also differs among trend data. As a result, in order to detect a significant change in trend data, the threshold value needs to be reset in accordance with the numerical value range of trend data. In other words, there has been a need to set the threshold value at a relatively small value when the numerical value range of trend data is relatively small, and to set the threshold value at a relatively large value when the numerical value range of trend data is relatively large. Thus, there occurs a problem that the threshold value appropriate to the numerical value range of each trend data needs to be set separately for each trend data in order to ensure the sensitivity to detect a change in trend data.

The present invention has been made to solve the above-described problems. An object of the present invention is to provide a condition monitoring system and a wind turbine, by which the sensitivity to detect a change in trend data of a vibration waveform can be simply improved.

### Solution to Problem

According to an aspect of the present invention, a condition monitoring system includes a vibration sensor and a processor. The condition monitoring system is configured to monitor a condition of a mechanical component in an apparatus. The vibration sensor is configured to measure a vibration waveform of the mechanical component. The processor includes an evaluation value computing unit and a diagnosis unit and is configured to detect a change in the vibration waveform. The evaluation value computing unit is configured to time-sequentially compute an evaluation value that characterizes a root-mean-square value of vibration waveform data output from the vibration sensor within a prescribed time period. The detector is configured to detect a change in the vibration waveform based on transition of the evaluation value. The evaluation value computing unit is configured to compute, as the evaluation value, a value based on kurtosis and skewness of a distribution of the root-mean-square value within the prescribed time period.

### Advantageous Effects of the Invention

According to the present invention, it becomes possible to provide a condition monitoring system and a wind turbine, by which the sensitivity to detect a change in trend data of a vibration waveform can be simply improved.

### BRIEF DESCRIPTION OF DRAWINGS

FIG. 1 is a diagram schematically showing the configuration of a wind turbine to which a condition monitoring system according to an embodiment of the present invention is applied.

FIG. 2 is a functional block diagram functionally showing the configuration of a data processor shown in FIG. 1.

FIG. 3 is a diagram showing an example of a temporal change in a differential value of vibration waveform data.

FIG. 4A is a diagram illustrating the definition of kurtosis.

FIG. 4B is a diagram illustrating the definition of skewness.

FIG. 5 is a conceptual diagram of a distribution occurring when a trend of data changes.

FIG. 6 is a diagram showing a temporal change in an evaluation value of a vibration waveform data example shown in FIG. 3.

FIG. 7 is a flowchart illustrating a control process for detecting a change in vibration waveform data in the condition monitoring system according to the embodiment of the present invention.

### DESCRIPTION OF EMBODIMENTS

Embodiments of the present invention will be hereinafter described in detail with reference to the accompanying drawings, in which the same or corresponding components are designated by the same reference characters, and the description thereof will not be repeated.

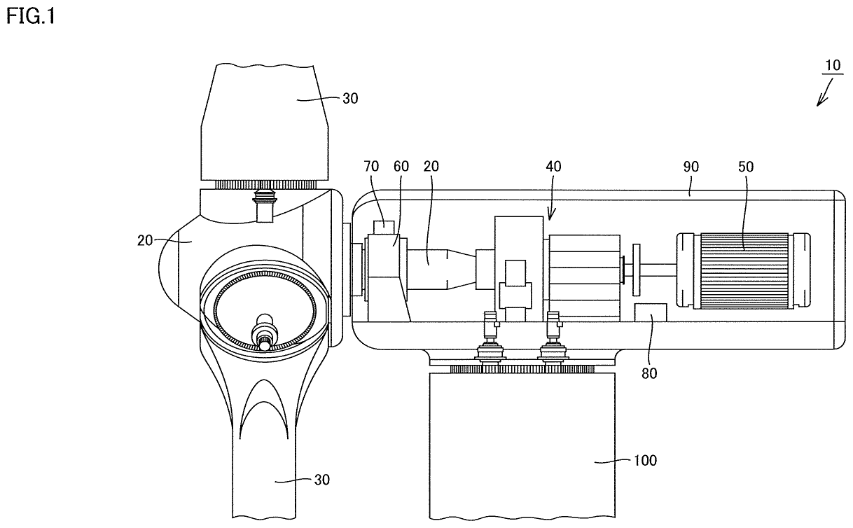

FIG. 1 is a diagram schematically showing the configuration of a wind turbine to which a condition monitoring system according to the present invention is applied. Referring to FIG. 1, wind turbine 10 includes a main shaft 20, a blade 30, a gearbox 40, a power generator 50, a main shaft bearing (hereinafter simply referred to as a “bearing”) 60, a vibration sensor 70, and a data processor 80. Gearbox 40, power generator 50, bearing 60, vibration sensor 70, and data processor 80 are installed in a nacelle 90 that is supported by a tower 100.

Main shaft 20 extends into nacelle 90 to be connected to the input shaft of gearbox 40. Main shaft 20 is also rotatably supported by bearing 60. Main shaft 20 transmits rotational torque generated by blade 30 receiving wind power to the input shaft of gearbox 40. Blade 30 is provided at the tip end of main shaft 20. Blade 30 converts wind power into rotational torque and transmits the rotational torque to main shaft 20.

Bearing 60 is fixed in nacelle 90 and rotatably supports main shaft 20. Bearing 60 is configured with a rolling bearing and, for example, configured with a self-aligning roller bearing, a tapered roller bearing, a cylindrical roller bearing, a ball bearing, or the like. These bearings may be a single row or a double row.

Vibration sensor 70 is fixed to bearing 60. Vibration sensor 70 measures the vibration waveform of bearing 60 and outputs the measured vibration waveform data to data processor 80. Vibration sensor 70 is configured with, for example, an acceleration sensor having a piezoelectric element.

Gearbox 40 is provided between main shaft 20 and power generator 50 to increase the rotational speed of main shaft 20 and output the increased rotational speed to power generator 50. As an example, gearbox 40 is configured with a gear speed-increasing mechanism including a planetary gear, an intermediate shaft, and a high-speed shaft. Although not shown, a plurality of bearings rotatably supporting a plurality of shafts are also provided in gearbox 40.

Power generator 50 is connected to the output shaft of gearbox 40 and generates electric power with the rotational torque received from gearbox 40. Power generator 50 is configured with, for example, an induction power generator. A bearing rotatably supporting the rotor is provided also in power generator 50.

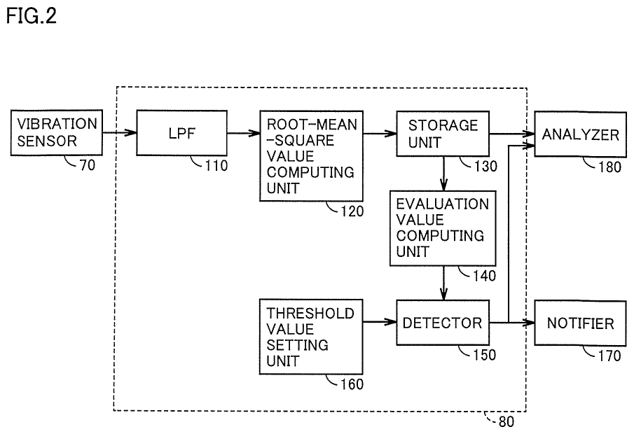

Data processor 80 is provided in nacelle 90 and receives vibration waveform data of bearing 60 from vibration sensor 70. Data processor 80 detects a change in vibration waveform data of bearing 60 according to a pre-set program. Also, data processor 80 transmits the vibration waveform data to an analyzer 180 and a notifier 170 that are external to wind turbine 10 (see FIG. 2).

FIG. 2 is a functional block diagram functionally showing the configuration of data processor 80 shown in FIG. 1. Referring to FIG. 2, data processor 80 includes a low pass filter (hereinafter referred to as “LPF”) 110, a root-mean-square value computing unit 120, a storage unit 130, an evaluation value computing unit 140, a detector 150, and a threshold value setting unit 160.

LPF 110 receives vibration waveform data of bearing 60 from vibration sensor 70. Regarding the received vibration waveform data, LPF 110 allows a signal component lower than a predetermined frequency (for example, 400 Hz) to pass therethrough, but cuts off a high frequency component.

Root-mean-square value computing unit 120 receives vibration waveform data of bearing 60 from LPF 110. Root-mean-square value computing unit 120 computes the root-mean-square value (also referred to as an “RMS (Root Mean Square) value”) of vibration waveform data of bearing 60 and outputs the computed root-mean-square value of vibration waveform data to storage unit 130.

Storage unit 130 stores the root-mean-square value of vibration waveform data of bearing 60 computed by root-mean-square value computing unit 120, from hour to hour. Storage unit 130 is configured with, for example, a readable and writable nonvolatile memory or the like.

Storage unit 130 is configured to store the root-mean-square value of vibration waveform data of bearing 60 at least within a prescribed time period (for example, seven days). For example, storage unit 130 is configured to, upon reception of vibration waveform data of bearing 60 from root-mean-square value computing unit 120 at predetermined time intervals (for example, two hours), erase the root-mean-square value of the oldest vibration waveform data among the root-mean-square values of vibration waveform data within a prescribed time period, and add the root-mean-square value of the newly input vibration waveform data.

Specifically, storage unit 130 updates, at predetermined time intervals, the root-mean-square value of vibration waveform data of bearing 60 within a prescribed time period. As will be described later, the root-mean-square value of vibration waveform data of bearing 60 within a prescribed time period stored in storage unit 130 is read, and the read root-mean-square value is used to detect a change in vibration waveform data. Also, storage unit 130 outputs the root-mean-square value of vibration waveform data to analyzer 180, which will be described later.

Evaluation value computing unit 140 reads root-mean-square values of vibration waveform data of bearing 60 within a prescribed time period from storage unit 130 and then computes an evaluation value that characterizes the read root-mean-square values of vibration waveform data within a prescribed time period. Evaluation value computing unit 140 is configured to time-sequentially compute the evaluation value. That is, evaluation value computing unit 140 updates the evaluation value at predetermined time intervals. The details of computation of the evaluation value by evaluation value computing unit 140 will be described later.

Threshold value setting unit 160 is used to set a threshold value that is used for detecting a change in vibration waveform data in detector 150. Threshold value setting unit 160 outputs the set threshold value to detector 150. Setting of the threshold value in threshold value setting unit 160 may be arbitrarily determined by a user or may be determined based on the vibration waveform data.

Detector 150 receives an evaluation value from evaluation value computing unit 140 and receives a threshold value from threshold value setting unit 160. Detector 150 compares the evaluation value with the threshold value to detect a change in vibration waveform data. Specifically, when the evaluation value is greater than the threshold value, detector 150 detects a change in vibration waveform data. On the other hand, when the evaluation value is equal to or smaller than the threshold value, detector 150 does not detect a change in vibration waveform data. Detector 150 also outputs the detection result to analyzer 180 and notifier 170.

Notifier 170 notifies a user located in a distant place about the detection result, for example, by methods such as a visual means or sound.

When analyzer 180 receives the information from detector 150 showing that a change in vibration waveform data has been detected, analyzer 180 starts to measure the vibration waveform data in response to this detection as a trigger. Specifically, analyzer 180 reads the root-mean-square value of the vibration waveform data stored in storage unit 130 since this trigger occurs. Analyzer 180 analyzes the read root-mean-square value of the vibration waveform data to thereby diagnose an abnormality in bearing 60. Such an analysis of vibration waveform data allows further detailed examination of the cause of the change in vibration waveform data of wind turbine 10 and the like (for example, damage to bearing 60, an environmental change and the like). The analysis of vibration waveform data by analyzer 180 may be performed by a program for automated analysis or performed manually by a user.

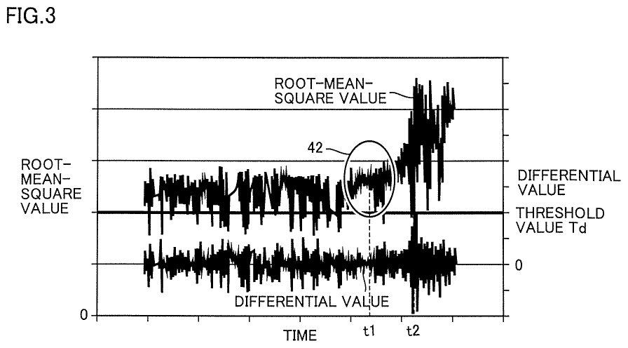

In the following, a method of detecting a change in vibration waveform data in detector 150 will be described. Referring to FIG. 3, an explanation will be first given with regard to a method of detecting a change in vibration waveform data using a differential value between the root-mean-square values, as a comparative example.

FIG. 3 is a diagram showing: an example of a temporal change in root-mean-square value of vibration waveform data of bearing 60 stored in storage unit 130; and a temporal change in differential value between the root-mean-square value. In the specification of the present application, the differential value between the root-mean-square values represents a value obtained by subtracting the root-mean-square value that has been previously stored from the root-mean-square value that is currently stored.

Referring to FIG. 3, the root-mean-square value changes over time. Regarding the tendency of the time series change of the root-mean-square value (hereinafter also referred to as a trend), the numerical value range of the root-mean-square value falls within a prescribed range in the time period before time t1. In contrast, the root-mean-square value significantly changes in the time period after time t1. The numerical value range of the root-mean-square value in this case extends to be relatively high on upper limit side. As a result, the center portion of the numerical value range is higher than that before time t1.

In this way, in the example in FIG. 3, the trend of the root-mean-square value changes at and around time t1 as shown in a region 42 surrounded by a circle in the figure. This trend change at and around time t1 shows, for example, a condition change in the measurement target that is represented by a significant change in root-mean-square value at and after time t1 or a change in environment such as a wind condition indicating how wind blows at the place where wind turbine 10 is installed. Accordingly, such a change in trend data needs to be detected.

The following is an explanation about detection of, based on a differential value, a condition change in the measurement target or a change in trend data showing an environmental change as mentioned above, as shown at time t1. In FIG. 3, a threshold value Td is set at a value higher than the numerical value range of the differential value in the time period before time t1.

As shown in FIG. 3, the differential value is lower than threshold value Td at time t1. Accordingly, any change in trend data at time t1 cannot be detected by using the differential value. In addition, the differential value exceeds threshold value Td at time t2 that is later than time t1. Thus, a change in trend data is detected at time t2 that is later than time t1.

In FIG. 3, threshold value Td needs to be reduced in order to reduce the deviation between: time t2 at which a change in trend data is detected based on the differential value; and time t1 at which the trend data actually changes in response to a condition change in the measurement target or an environmental change. However, the differential value at time t1 is approximately equal to the differential value at the time before time t1. Accordingly, when threshold value Td is reduced, a trend change in trend data (hereinafter also referred to as a change in trend data) is to be erroneously detected in the time period before time t1 and during which a change in trend data does not occur.

According to the method of detecting a change in trend data using the differential value between the root-mean-square values in this way, threshold value Td is limited by the numerical value range of the differential value for the purpose of preventing erroneous detection. As a result, the above-mentioned method causes a problem that a change in trend data cannot be recognized until the numerical value range of the differential value sufficiently increases.

Furthermore, the numerical value range of the differential value also differs depending on the numerical value range of the root-mean-square value. Accordingly, there is also a problem that the threshold value appropriate to the numerical value range of each trend data needs to be set separately for each trend data in order to ensure the sensitivity to detect a change in trend data (hereinafter also referred to as detection sensitivity).

Thus, the present embodiment includes a configuration in which an evaluation value that characterizes the root-mean-square value of vibration waveform data within a prescribed time period is time-sequentially computed, and a change in vibration waveform is detected based on transition of the computed evaluation value. In the above-described configuration, the evaluation value is defined as a value based on the kurtosis and the skewness of the distribution of the root-mean-square value within a prescribed time period.

Kurtosis and skewness each are a statistical value showing the shape of distribution and also a value that is rendered dimensionless unlike a differential value. Thus, the characteristics of the distribution of the root-mean-square value within a prescribed time period can be represented irrespective of the numerical value range of the root-mean-square value. Accordingly, various threshold values do not need to be set for the numerical value ranges of various root-mean-square values, so that a common threshold value can be used. Thereby, the sensitivity to detect a change in trend data can be simply improved.

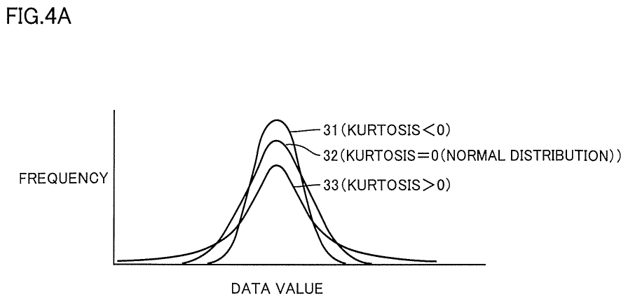

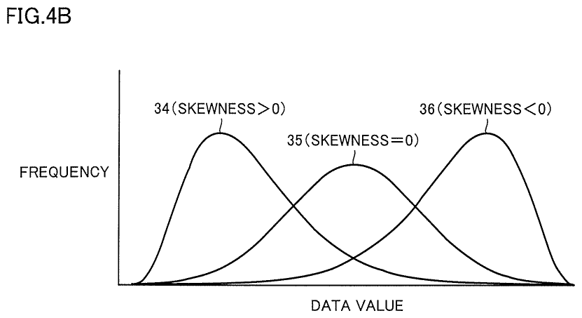

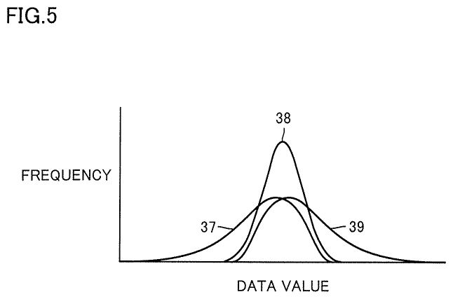

In the following, the definitions of kurtosis and skewness will be described with reference to FIGS. 4A, 4B and 5.

FIG. 4A is a diagram illustrating the definition of kurtosis. As a statistical value showing the shape of distribution of the root-mean-square value within a prescribed time period, kurtosis shows the degree of peakedness of the distribution. Generally, kurtosis tends to be zero in the case of a normal distribution (see graph 32), tends to be a positive value in the case where a tail is relatively thick as compared with the normal distribution (see graph 33), and tends to be a negative value in the case where a tail is relatively thin as compared with the normal distribution (see graph 31). In the data used in the present embodiment, the kurtosis of the distribution is approximately positive. In other words, in the present embodiment, as the absolute value of kurtosis is smaller, data concentrates more around the average value.

More specifically, the thickness of the tail of the distribution shows the degree at which data concentrates around the average value of the distribution. In the following description, assuming that the number of pieces of data of the root-mean-square value within a prescribed time period is defined as n, the data of the root-mean-square value will be represented as x₁, x₂, . . . and xₙ. Assuming that an average value is defined as μ, a standard deviation is defined as σ and kurtosis is defined as K in the distribution of the root-mean-square value data x₁, x₂, and . . . xₙ, then, μ, σ and K are represented by the following equations (1), (2) and (3), respectively.

$$\begin{matrix}[ Equation 1 ] & \\ μ = \frac{1}{n} {\sum }_{i = 1}^{n} {x}_{i} & ( 1 ) \\ [ Equation 2 ] & \\ σ = \sqrt{\frac{1}{n} {\sum }_{i = 1}^{n} {( {x}_{i} - μ )}^{2}} & ( 2 ) \\ [ Equation 3 ] & \\ K = \frac{1}{n {σ}^{4}} {\sum }_{i = 1}^{n} {( {x}_{i} - μ )}^{4} - 3 & ( 3 )\end{matrix}$$

FIG. 4B is a diagram illustrating the definition of skewness. Skewness indicates the bilateral symmetry (distortion) of the distribution. Skewness is zero when the distribution is bilaterally symmetrical (see graph 35), a positive value when the distribution is skewed to the negative side (left side) as compared with the case where the distribution is bilaterally symmetrical (see graph 34), and a negative value when the distribution is skewed to the positive side (right side) as compared with the case where the distribution is bilaterally symmetrical (see graph 36). In other words, as the absolute value of skewness is larger, the data distribution is skewed more to the positive side or the negative side.

More specifically, assuming that skewness is defined as S, S is represented by the following equation (4).

$$\begin{matrix}[ Equation 4 ] & \\ S = \frac{1}{n {σ}^{3}} {\sum }_{i = 1}^{n} {( {x}_{i} - μ )}^{3} & ( 4 )\end{matrix}$$

Then, referring to FIG. 5, an explanation will be given with regard to changes in kurtosis and skewness that may appear when a trend change occurs in the time-series data such as vibration waveform data in the present specification. FIG. 5 is a conceptual diagram of the distribution occurring when the trend of data changes.

The following is an explanation about the case where an upward trend of data occurs. It is considered that, when an upward trend occurs, an outlier value starts to appear on the positive side (right side) as compared with the case before occurrence of the upward trend. Accordingly, it is considered that the distribution of data appearing in the case of an upward trend is expanded more to the positive side (the tail thickens) (see graph 39) as compared with the distribution in the preceding time period (see graph 38). In other words, it is considered that the value of kurtosis is positively increased and the value of skewness is positively increased.

The following is an explanation about the case where a downward trend of data occurs. It is considered that, when a downward trend occurs, an outlier value starts to appear on the negative side (left side) as compared with the case before occurrence of the downward trend. Accordingly, it is considered that the distribution of data appearing in the case of a downward trend is expanded more to the negative side (the tail thickens) (see graph 37) as compared with the distribution in the preceding time period (see graph 38). In other words, it is considered that the value of kurtosis is positively increased and the value of skewness is negatively increased.

Specifically, it is considered that, when an upward trend or a downward trend occurs in the time-series data such as vibration waveform data in the present specification, the value of kurtosis is positively increased and the value of skewness is positively or negatively increased. In other words, each of the absolute values of kurtosis and skewness is increased. Thus, in the present embodiment, the value based on the kurtosis and the skewness of the distribution of the root-mean-square value within a prescribed time period is computed as an evaluation value for detecting a change in vibration waveform data. More preferably, the absolute value of the product of kurtosis and skewness is computed as an evaluation value.

In the present embodiment, as described above, an absolute value of the product of kurtosis K and skewness S of the distribution of the root-mean-square value within a prescribed time period is computed as an evaluation value. Assuming that an evaluation value is defined as P, evaluation value P is represented by the following equation (5).

P=|KS| (5)

As can be seen from the equation (5), evaluation value P becomes larger as kurtosis K becomes larger. Also, evaluation value P becomes larger as the absolute value of skewness S becomes larger. Accordingly, in the distribution of the root-mean-square value within a prescribed time period, when the tail of data becomes thicker on the negative side (left side) (see graph 37 in FIG. 5) or when the tail of data becomes thicker on the positive side (right side) (see graph 39 in FIG. 5), evaluation value P becomes larger.

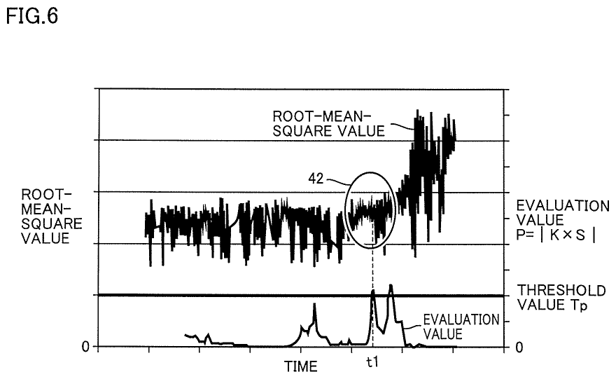

FIG. 6 is a diagram showing a temporal change of evaluation value P with respect to the temporal change of the root-mean-square value shown in FIG. 3.

Referring to FIG. 6, evaluation value P abruptly increases at and around time t1. This indicates that a change occurs also in the distribution of the root-mean-square value within a prescribed time period in response to a change in trend data, and more specifically indicates occurrence of distortion in which data concentrates on the negative side or the positive side in the distribution of the root-mean-square value within a prescribed time period, as described above.

As shown in FIG. 6, by setting a threshold value Tp at a value that is approximately equal to evaluation value P at time t1, a change in trend data at and around time t1 can be detected. Since evaluation value P is an absolute value of the product of kurtosis K and skewness S, this evaluation value P is a value that is rendered dimensionless like kurtosis K and skewness S. In other words, the same threshold value Tp can be set for the numerical value ranges of various root-mean-square values. This also allows detection of a change that is difficult to be detected by the differential value. As a result, the sensitivity to detect a change in trend data can be improved.

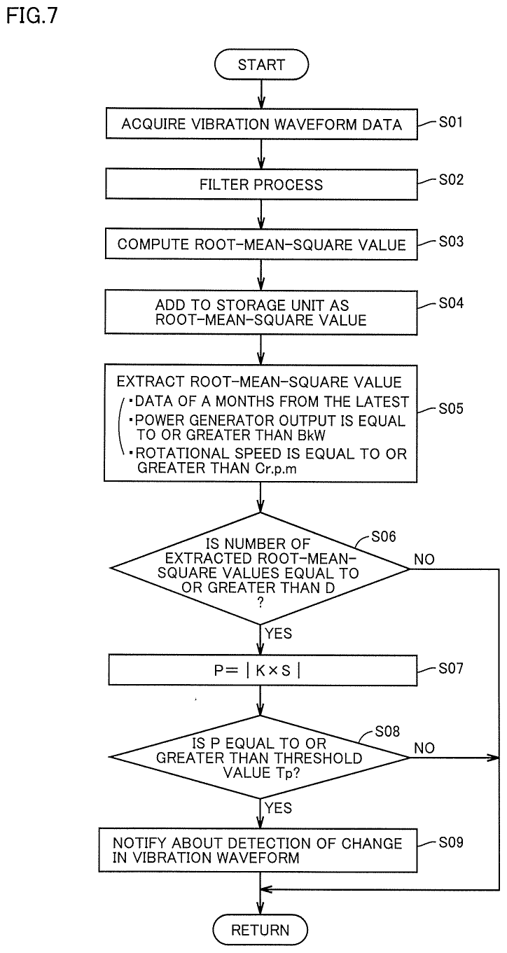

FIG. 7 is a flowchart illustrating a control process for detecting a change in vibration waveform in the condition monitoring system according to the present embodiment. The control process shown in FIG. 7 is repeatedly performed by data processor 80 at predetermined time intervals.

Referring to FIG. 7, in step S01, data processor 80 receives vibration waveform data of bearing 60 from vibration sensor 70. Then, in step S02, LPF 110 executes a filter process on the vibration waveform data of bearing 60.

Then, in step S03, when receiving the filter-processed vibration waveform data of bearing 60 from LPF 110, data processor 80 causes root-mean-square value computing unit 120 to calculate the root-mean-square value of vibration waveform data of bearing 60. In step S04, data processor 80 causes storage unit 130 to store the root-mean-square value of the vibration waveform data calculated by root-mean-square value computing unit 120.

Then, in step S05, data processor 80 causes root-mean-square value computing unit 120 to extract the root-mean-square value satisfying a prescribed condition from all of the root-mean-square value data. Specifically, from among the root-mean-square values stored in storage unit 130, data processor 80 extracts only the data included in the latest data for a prescribed time period and satisfying the condition that the power generator output is equal to or greater than a prescribed value and that the rotational speed is equal to or greater than a prescribed value.

Evaluation value computing unit 140 of data processor 80 determines in step S06 whether or not the number of pieces of data of the root-mean-square value extracted in step S05 is equal to or greater than a prescribed number. When the number of pieces of data of the root-mean-square value of the vibration waveform data extracted in step S05 is less than the prescribed number (NO in S06), the subsequent steps S07 to S09 are skipped, and the process is returned to a main routine.

On the other hand, when the number of pieces of data extracted in step S05 is equal to or greater then the prescribed number (YES in S06), the process proceeds to step S07, in which data processor 80 causes evaluation value computing unit 140 to compute evaluation value P of the extracted root-mean-square value of the prescribed number of pieces of the vibration waveform data. In this case, evaluation value P is an absolute value of the product of kurtosis K and skewness S of the root-mean-square value, as described above.

In step S08, data processor 80 causes detector 150 to compare the computed evaluation value P with threshold value Tp. When evaluation value P is less than threshold value Tp (NO in S08), data processor 80 skips the subsequent step S09 and returns the process to a main routine. On the other hand, when evaluation value P is equal to or greater than threshold value Tp (YES in S08), then in step S09, data processor 80 causes detector 150 to output the detection result to notifier 170 and analyzer 180 (see FIG. 2). Then, notifier 170 notifies a user about detection of a change in vibration waveform. Analyzer 180 analyzes the root-mean-square value of the vibration waveform data stored in storage unit 130 after this detection to thereby diagnose an abnormality in wind turbine 10. As a result, the event that causes a change in vibration waveform (for example, a predictive sign of serious failure) can be recognized at an early stage.

As described above, according to the present embodiment, an evaluation value that characterizes the root-mean-square value of vibration waveform data of bearing 60 within a prescribed time period is calculated based on the kurtosis and the skewness of the distribution of the root-mean-square value within the prescribed time period. This eliminates the need to set a threshold value in consideration of the numerical value range of trend data. Accordingly, even a change that is difficult to be detected by the differential value can also be detected. As a result, the sensitivity to detect a change in trend data can be improved. Specifically, it becomes possible to detect, for example, damage to a mechanical component that is a predictive sign of a serious failure and that is difficult to be detected by a differential value.

Preferably, an absolute value of the product of kurtosis and skewness of the distribution of the root-mean-square value within a prescribed time period is used as an evaluation value. In this case, when a change occurs in such a manner that a tail thickens on the positive side or the negative side in the distribution of the root-mean-square value within a prescribed time period, the evaluation value also changes so as to reflect such a change. Thus, by recognizing this change in evaluation value, a change in trend data can be detected.

It should be understood that the embodiments disclosed herein are illustrative and non-restrictive in every respect. The scope of the present invention is defined by the terms of the claims, rather than the description of the embodiments provided above, and is intended to include any modifications within the meaning and scope equivalent to the terms of the claims.

### REFERENCE SIGNS LIST

10 wind turbine, 20 main shaft, 30 blade, 40 gearbox, 42 change in root-mean-square value, 50 power generator, 60 bearing, 70 vibration sensor 80 data processor, 90 nacelle, 100 tower, 120 root-mean-square value computing unit, 130 storage unit, 140 evaluation value computing unit, 150 detector, 160 threshold value setting unit, 170 notifier, 180 analyzer, P evaluation value, Td, Tp threshold value.

1. A condition monitoring system configured to monitor a condition of a mechanical component in an apparatus, the condition monitoring system comprising:
a vibration sensor configured to measure a vibration waveform of the mechanical component; and
a processor configured to detect a change in the vibration waveform,
the processor including
an evaluation value computing unit configured to time-sequentially compute an evaluation value that characterizes a root-mean-square value of vibration waveform data output from the vibration sensor within a prescribed time period, and
a detector configured to detect a change in the vibration waveform based on transition of the evaluation value,
the evaluation value computing unit being configured to compute, as the evaluation value, a value based on kurtosis and skewness of a distribution of the root-mean-square value within the prescribed time period.

2. The condition monitoring system according to claim 1, wherein the evaluation value computing unit is configured to compute, as the evaluation value, an absolute value of a product of kurtosis and skewness of the distribution of the root-mean-square value within the prescribed time period.

3. The condition monitoring system according to claim 1, wherein the detector is configured to detect a change in the vibration waveform when the evaluation value exceeds a threshold value.

4. The condition monitoring system according to claim 2, wherein the detector is configured to detect a change in the vibration waveform when the evaluation value exceeds a threshold value.

5. A wind turbine comprising the condition monitoring system according to claim 1.
